(19) United States
(12) Patent Application Publication
(10) Pub. No.: US 2015/0032038 A1
(43) Pub. Date: Jan. 29, 2015

(54) Self-Actuated Muscle Compression Device

(71) Applicant: Ali Sied Atry, Houston, TX (US)

(72) Inventor: Ali Sied Atry, Houston, TX (US)

(21) Appl. No.: 14/341,506

(22) Filed: Jul. 25, 2014

Related U.S. Application Data
(60) Provisional application No. 61/859,094, filed on Jul. 26, 2013.

(51) Int. Cl. A61H 1/00

(52) U.S. Cl. CPC A61H 1/008; A61H 2201/0173
USPC 601/84

(57) ABSTRACT

Provided herein are muscle compression devices and self-actuated muscle compression devices. The devices generally comprise at least one encompassing member with an inner surface substantially contacting a muscle perimeter in at least one location on the subject's skin, at least one compression member disposed on the inner surface and at least one actuator disposed on the encompassing member in a tightening relationship therewith. The components of the device may be arranged as single clasping loops around the subject or as a vest or harness worn by the subject. Also provided is a method for compressing a muscle in which the device is positioned on the subject and the actuators are self-actuated to tighten the encompassing members. Tightening results in the compression members contacting the muscle target site with increasing compressive force.

### CROSS-REFERENCE TO RELATED APPLICATIONS

This nonprovisional application claims benefit of priority under 35 U.S.C. §119(e) of provisional application U.S. Ser. No. 61/859,094, filed Jul. 26, 2013, now abandoned, the entirety of which is hereby incorporated by reference.

### BACKGROUND OF THE INVENTION

1. Field of the Invention

The present invention relates generally to a muscle compression device and its use for reducing muscle tension and other conditions. More particularly, this invention relates to a muscle compression device that uses self-actuation to apply pressure/force in a targeted manner to eliminate or alleviate pain caused by injury or disease to a specific muscle or muscle group and to prevent further injury thereto.

2. Description of the Related Art

Various products, such as foam rollers, compression foam balls, leveraging sticks, produce muscular release of tension through compression. None of these devices, however, provide greater pressure than the force of gravity being exerted on the body. For example, foam rollers, dense foam balls, rubber balls, and other products, used for myofascial release, are unable to place pressure directly on top of the levator scapulae or on the top of the trapezius muscle without causing contortion of the cervical spine area. Compression sticks use leveraging of a user's body, via an axis/fulcrum on the body, to create force on the trapezius and surrounding muscles. However, a major limitation of this technique is that the force/pressure generated is limited by the user's own strength. Furthermore, this technique causes the user to exert greater effort via contraction of muscles to generate leveraging, contrary to the principal of muscular release.

Thus, there is a recognized need in the art for improved muscle compression devices. Specifically, the prior art is deficient in a muscle compression device utilizing self-actuating to apply pressure to muscle(s) in a targeted manner. The present invention fulfills this longstanding need and desire in the art.

### SUMMARY OF THE INVENTION

The present invention is directed to a muscle compression device for use by a subject. The device comprises at least one encompassing member that has an inner surface and an outer surface where the inner surface substantially contacts a muscle perimeter in at least one location on the subject's skin. The device comprises at least one compression member disposed on the inner surface of the encompassing member and at least one actuator disposed on the encompassing member in a tightening relationship therewith. A related device further comprises means for attaching the compression member to the encompassing member. Another related device further comprises a compression member actuator and means for actuating the same disposed in the compression member where the actuator is extendible within the compression member.

The present invention is further directed to a self-actuating muscle compression device. This device comprises a plurality of interconnected flexible encompassing members forming a shoulder portion, a front portion and a back portion as a single piece. A pair of compression members are disposed on the inner surfaces of the encompassing members on the back portion of the device and each has a plurality of portions extending laterally therefrom where each of the portions is attached to more than one of the encompassing members or attached to one encompassing member. A plurality of actuators are disposed on the encompassing members on the front portion. A related device further comprises a single encompassing member separate from the interconnected flexible encompassing members and having one or more of the portions of the compression members attached thereto. An actuator is disposed on the encompassing member on the front portion in a tightening relationship therewith.

The present invention is directed further to another self-actuating muscle compression device. This device comprises a plurality of interconnected flexible encompassing members that form a shoulder portion, a front portion and a back portion as a single piece. A plurality of compression elements, where each is a single compression node, are movably secured at any positions on inner surfaces of the encompassing members. A plurality of actuators are disposed on the encompassing members on the front portion such that disengagement or engagement of the actuators comprises means for opening or closing the front portion. A related device further comprises a single encompassing member separate from the interconnected flexible encompassing members. One or more compression members are movably secured at any position on an inner surface of the encompassing member. An actuator is disposed on the encompassing member in a tightening relationship therewith.

The present invention is directed further still to a method of compressing a muscle at a target site on a subject in need thereof. The method comprises positioning the device as described herein on the subject and tightening one or more encompassing members via the actuators comprising the device. The target site is contacted with one or more of the compression members disposed on the encompassing members with an increasing pressure as the encompassing members tighten, thereby compressing the muscle at the target site in the subject. The present invention is directed to a related method where the compression members comprise an actuator and means for actuating the same and the method further comprises actuating, manually or electronically, the actuator prior to or after tightening the encompassing members.

Other and further aspects, features, and advantages of the present invention will be apparent from the following description of the presently preferred embodiments of the invention. These embodiments are given for the purpose of disclosure.

### BRIEF DESCRIPTION OF THE DRAWINGS

So that the matter in which the above-recited features, advantages and objects of the invention, as well as others which will become clear, are attained and can be understood in detail, more particular descriptions and certain embodiments of the invention briefly summarized above are illustrated in the appended drawings. These drawings form a part of the specification. It is to be noted, however, that the appended drawings illustrate preferred embodiments of the invention and therefore are not to be considered limiting in their scope.

FIG. 1 depicts a single loop self-actuated muscle compression device comprising movable and/or removable compressing members.

FIG. 2 depicts a single loop self-actuated muscle compression device comprising a plurality of compressing members formed from the surface thereof.

FIG. 3 depicts a single loop self-actuated muscle compression device comprising a plurality of marbles as compressing members movable thereon.

FIGS. 4A-4B depict front (FIG. 4A) and back (FIG. 4B) views of a self-actuated muscle compression apparatus worn as a by a subject.

FIG. 5. depicts a self-actuated muscle compression apparatus comprising a plurality of movable compression members in a harness configuration.

FIG. 6. is a cross-section of a compression member comprising an actuator as disposed on an encompassing member.

### DETAILED DESCRIPTION OF THE INVENTION

As used herein in the specification, “a” or “an” may mean one or more. As used herein in the claim(s), when used in conjunction with the word “comprising”, the words “a” or “an” may mean one or more than one.

As used herein “another” or “other” may mean at least a second or more of the same or different claim element or components thereof. Similarly, the word “or” is intended to include “and” unless the context clearly indicates otherwise. “Comprise” means “include.”

As used herein, the term “about” refers to a numeric value, including, for example, whole numbers, fractions, and percentages, whether or not explicitly indicated. The term “about” generally refers to a range of numerical values (e.g., +/−5-10% of the recited value) that one of ordinary skill in the art would consider equivalent to the recited value (e.g., having the same function or result). In some instances, the term “about” may include numerical values that are rounded to the nearest significant figure.

As used herein, the terms “subject” or “user” refer to any individual utilizing any embodiment of self-actuated muscle compression device as described herein.

In one embodiment of the present invention there is provided a muscle compression device for use by a subject, comprising at least one encompassing member having an inner surface and an outer surface, said inner surface substantially contacting a muscle perimeter in at least one location on the subject's skin; at least one compression member disposed on the inner surface of the encompassing member; and at least one actuator disposed on the encompassing member in a tightening relationship therewith.

Further to this embodiment the device comprises means for attaching the compression member to the encompassing member. In this further embodiment, the compression member may be removably attached to the encompassing member or may be movable along the length of the encompassing member or a combination thereof. Examples of an attaching means are a hook and button closure, glue, velcro, a clip, or a snap or wherein the compressing member is sewn to the encompassing member.

In another further embodiment, the device may comprise a compression member actuator and means for actuating the same disposed in the compression member, said actuator extendible within the compression member. In this further embodiment, the actuating means may comprise manual actuation, electronic actuation or remote actuation and the compression member actuator comprises an extendible rod.

In all these embodiments, a plurality of the encompassing members may be interconnected to form a shoulder portion, a front portion and a back portion encircling the torso, where the compression elements are attached at a plurality of locations along the encompassing members and the actuators are disposed on the encompassing members on the front portion. In one aspect, the device may comprise a vest with a pair of compression elements on the back portion of the device each having a plurality of portions extending laterally therefrom and attached to locations on more than one encompassing member or affixed to one encompassing member. In another aspect, the device may comprise a harness with a plurality of compression elements each being a single compression node movably secured at any positions along the encompassing members.

In all embodiments and aspects thereof the encompassing member may comprise a strap, a semi-rigid or rigid circular clasping loop, a chain, a belt, a rope, or a combination thereof. Alternatively, the encompassing member and the compressing member may be a single member having the compressing members extruded from the inner surface of the encompassing member. Also, the compression member may comprise a polymer, glass, rubber, a dense foam, metal, or wood. In addition, the actuator may comprises at least one mechanical element or at least one electrical element or a combination thereof. Representative examples of the mechanical element include but are not limited to a ratchet, a leveraging tool, a rod, a toothed wheel, an eccentric wheel, or a pulley. Representative examples of the electrical element include but are not limited to a battery operated ratchet or a motorized pulley.

In another embodiment of the present invention, there is provided a self-actuating muscle compression device, comprising a plurality of interconnected encompassing members forming a shoulder portion, a front portion and a back portion as a single piece; a pair of compression members disposed on the inner surfaces of the encompassing members on the back portion of the device and each having a plurality of portions extending laterally therefrom, each of said portions attached to more than one of the encompassing members or attached to one encompassing member; and a plurality of actuators disposed on the encompassing members on the front portion.

Further to this embodiment, the device comprises a single encompassing member separate from the interconnected encompassing members and having one or more of the portions of the compression members attached thereto; and an actuator disposed on the encompassing member on the front portion in a tightening relationship therewith.

In this embodiment, the compression members may comprise a plurality of polymer-filled pouches each having an actuator and means for actuating the same. In a particular example, the actuating means may comprise manual actuation, electronic actuation or remote actuation. Also, in this embodiment the device may comprise a vest wearable by the subject.

In yet another embodiment of the present invention, there is provided a self-actuating muscle compression device, comprising a plurality of interconnected encompassing members forming a shoulder portion, a front portion and a back portion as a single piece; a plurality of compression elements each being a single compression node movably secured at any positions on inner surfaces of the encompassing members; and a plurality of actuators disposed on the encompassing members on the front portion.

Further to this embodiment device comprises a single encompassing member separate from the interconnected encompassing members; one or more compression members movably secured at any position on an inner surface of the encompassing member; and an actuator disposed on the encompassing member in a tightening relationship therewith.

In both embodiments the compression members may comprise the polymer-filled pouches, actuator and actuating means as described supra. Also in this embodiment the single piece may comprise a harness wearable by the subject.

In yet another embodiment of the present invention, there is provided a method for compressing a muscle at a target site on a subject in need thereof comprising the steps of positioning the device as described supra on the subject; tightening one or more encompassing members via the actuators comprising the device; and contacting the muscle target site with one or more of the compression members disposed on the encompassing members with an increasing pressure as the encompassing members tighten, thereby compressing the muscle at the target site in the subject. Further to this embodiment, the compression members may comprise an actuator and means for actuating the same where the method comprises actuating, manually or electronically, the actuator prior to or after the tightening step. In both embodiments, the subject may suffer from muscular pain or from altered reciprocal inhibition of the muscle or may have a decreased range of muscular motion.

Provided herein are devices and methods for self-actuating muscle compression. The components of a basic self-actuating device comprise an encompassing member configured to encircle a subject and a compression member and an actuator disposed thereon. Generally, in use the actuator removably receives a portion, end, tip, or tongue of the encompassing member therein and upon actuation tightens or increases the tension of the entire encompassing member which causes the compression member to exert an increasing compressive force on a muscle or group of muscles as the encompassing member becomes increasingly tighter. This treats or alleviates an undesirable condition of the muscles and results in relaxing the muscles so treated.

Because the device is self-actuating, the subject or user thereof can configure the device and regulate the level of compression. Alternatively, another person can configure and actuate the device for the subject. For example, a physical therapist or other medical professional can determine an appropriate level of compression for one or more of the compressing members and actuate the device.

The device may comprise a single set of components or a plurality of sets each individually positionable on and/or encircling the subject. Alternatively, a plurality of components may be interconnected to form a device wearable as a garment such as a vest or harness. This enables an increased number of muscles or muscle groups to be compressed simultaneously or, alternatively, specific sites over a greater area of the body may be selected for compression.

In these devices, the encompassing member is formed of a material to fit the contour of the muscle on the body and has a high tensile strength to create compression when tightened by the actuator. The encompassing member may have a flexible, semi-rigid or rigid structure or composition. In non-limiting examples, the encompassing member may comprise a strap, a belt, a semi-rigid to rigid substantially circular clasping loop, a rope, a chain, or a fabric or a combination thereof. The encompassing member may be made of representative materials including but not limited to woven nylon, woven cotton, semi-rigid polymer, rubber, metal in the form of a flexible chain or flexible cable, leather. The encompassing loop may be made of fabrics such as, but not limited to, polyesters, polypropylenes, acrylics, cellulose acetates, or spandex. The encompassing member may comprise a combination of materials and forms. For example, the encompassing member may be a strap/loop combination made of nylon with the tip or tongue receivable within the actuator comprising a semi-flexible material to fit therein.

The compression member may have any 3-dimensional shape, such as but not limited to, a spherical or hemispherical shape, a conical shape, a cube, a cylindrical shape, an ovoid shape, a nodular shape or any irregular shape, such as comprising a groove or grooved portion or compressed version thereof. The compression member may comprise wood, metal, rubber, a polymer, glass, or a dense foam. For example, the compression member may be polymer beads or glass marbles. The compression member may be contained within a pouch, such as a compressible polymer pouch.

The compression member may further comprise an actuator in communication with means for actuating the same. The actuating means may be actuated manually or via mechanical, electrical, electronic means as are known in the art and may be remotely actuated such as with a standard battery operated remote control device or other wired or wireless electronic devices or computer controlled. Particularly, the actuating means may be, but not limited to, a button, switch, lever, screw head, motor, chip or card. The actuator may be a rod or a screw disposed within the compression member and in communication with the actuating means disposed on the surface of the compression member.

The actuator for the encompassing member may be mechanical, such as a rachet, a reel, a wheel, a pulley system, a stick or a combination thereof. The actuator may be made of metal, wood, a polymer or a combination thereof. The actuator may be manually actuated or electrically actuated, such as with a battery.

The self-actuating muscle compression devices provided herein are utilized to apply pressure to a muscle or muscle group in a targeted manner, for example, the trapezius, or levator scapulae, or to any other muscle or muscle group of the body. The system described here can be adapted to fit around any affected part of the body regardless of body weight or shape. Additionally, depending on the construction of the device, the force/pressure can far exceed that provided by gravity and or pressure generated through applied pressure through leverage and is only limited by the pain tolerance level of the subject. The compression devices described here can exert pressure on a target point within a muscle, on a greater amount of surface area of a muscle, and on multiple muscle groups simultaneously.

Thus, the present invention provides methods of compressing an/or treating one or more muscles and/or muscle groups in a subject via the self-actuating muscle compression devices described herein. The subject positions or dons any embodiment of the device described herein and positions or adjusts the compression members to rest against the targeted site or sites. Once actuated by the subject, the compression members produce a compressive force at the targeted site(s). In addition, as a means to alleviate muscular tension/stress, the device may comprise means to apply vibrations, heat, hot or cold compresses or a magnetic field, before, during or after the compression. Moreover, the device may be used with transcutaneous electrical nerve stimulation (TENS) as is known in the art prior to, during or after actuation of the device. The subject utilizing the compression device may suffer from muscular pain or altered reciprocal inhibition of the muscle or the subject may have a decreased range of muscular motion.

As described below, the invention provides a number of advantages and uses, however such advantages and uses are not limited by such description. Embodiments of the present invention are better illustrated with reference to the Figure(s), however, such reference is not meant to limit the present invention in any fashion. The embodiments and variations described in detail herein are to be interpreted by the appended claims and equivalents thereof.

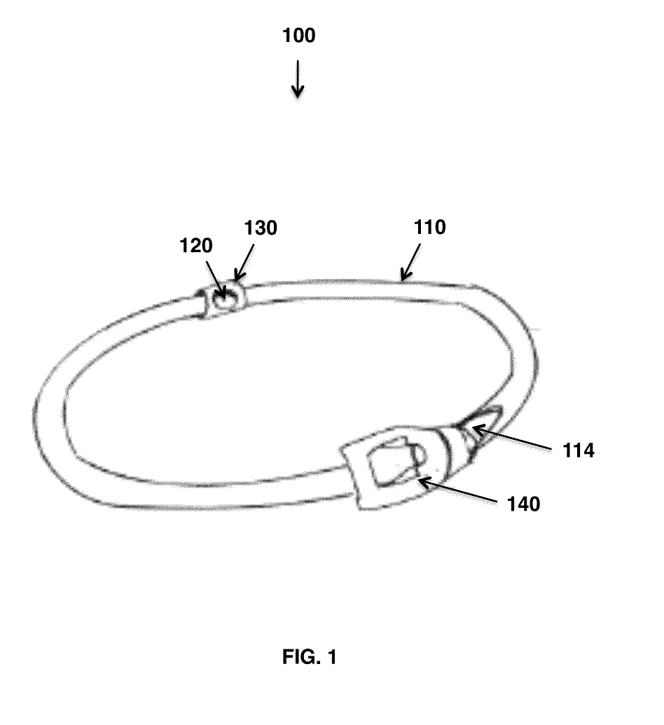

FIG. 1 illustrates an embodiment of the self-actuated compression device. The compression device 100 comprises a single encompassing member 110, for example, a clasping loop, a belt or a combination structure. The encompassing member comprises at least one compressing member, as represented by 120, disposed thereon via an attachment means 130 and an actuator 140, for example, a ratchet disposed on the securing end 112, for example, a buckle or clasp end, of the encompassing member such that the tip end 114 of the encompassing member is slidably received through and engagable with the actuator.

In this embodiment the compressing member is depicted as a single node in the compression device. However, the encompassing means can comprise a plurality of compressing members. The attachment means may be affixed permanently to the encompassing member or may be movable along the encompassing member. The single compressing member may be strategically placed or moved to a desired placement to target a specific muscle or muscle group. Alternatively, a plurality of movable compressing members may be removably disposed along the encompassing member. The movable compressing members may be positioned in any configuration along the encompassing means as desired by the subject to target larger or smaller areas of interest. The attachment means may comprise a material that is sewn to the encompassing means to secure the compressing means in place. The attachment means may removably secure the compressing means via Velcro, a snap, a button or a clip. For example, the female component of a snap can be affixed to one or more places along the inner surface of the encompassing member and the male component of the snap can be affixed to one or more compressing members.

The encompassing member is shown in a closed configuration as when secured around a subject. When actuated the actuator tightens the encompassing member around the subject, the compressing member is pulled against the muscle or muscle group of interest thereby exerting pressure against the same. The subject may adjust the tension of the encompassing member with the actuator to a desired level, that is increase, decrease or release the pressure exerted by the compressing member.

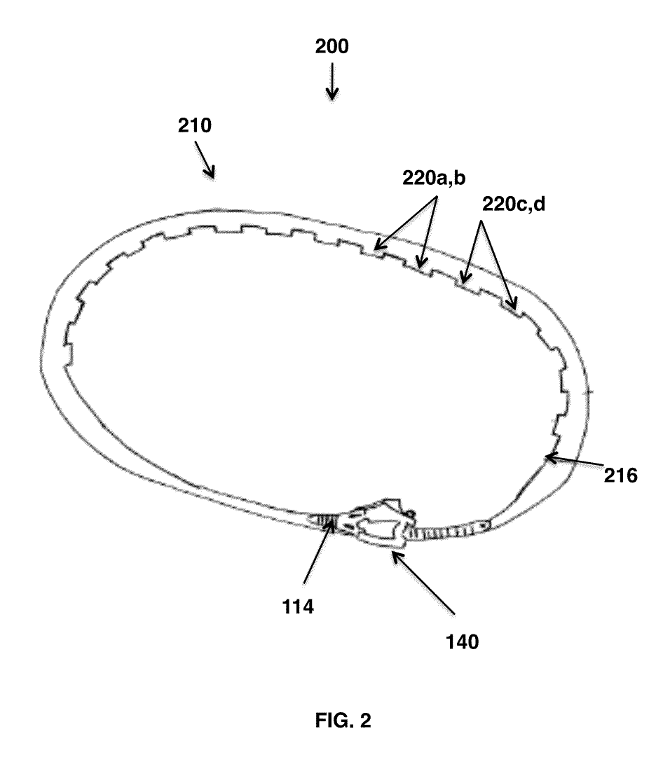

FIG. 2 illustrates another embodiment of the self-actuated compression device. The compression device 200 comprises a single loop encompassing member 210 having a plurality of compressing members, as represented by 220a,b.c,d, formed from and around the inner surface 216 of the encompassing member. In a non-limiting example the encompassing member may comprise an extruded polymer loop. The encompassing member is shown in a closed or secured configuration and comprises an actuator 140 as per FIG. 1. The compressing members comprise a plurality of semi-rigid nodes that all exert pressure equally on the subject when tension on the encompassing member is increased via the actuator as described in FIG. 1.

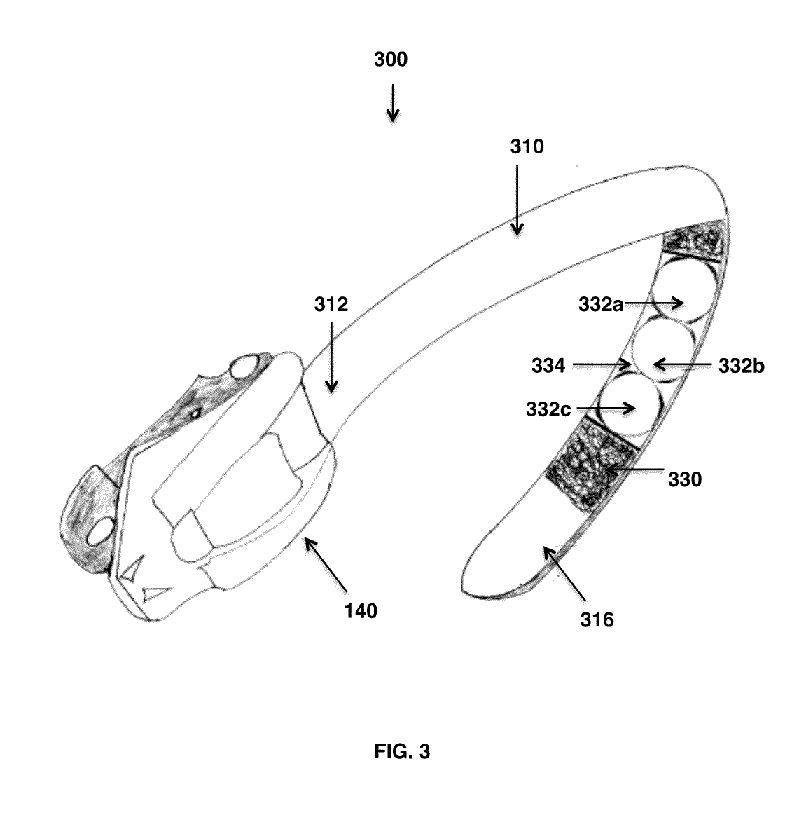

FIG. 3 illustrates another embodiment of the self-actuated compression device. The compression device 300 comprises a single loop encompassing member 310 and an actuator 140 disposed on the securing end 312 of the encompassing member as per FIGS. 1 and 2. The encompassing means is shown in an open or unsecured configuration and, in a non-limiting example, may comprise a nylon strapping material. The inner surface 316 of the encompassing means may comprise an attachment means 330, for example, a Velcro strip where the female component of the strip is disposed along the inner surface. The compressing member comprises a plurality of marbles or beads, represented by 332a,b,c, contained within a movable pouch 334 that has the male component of the Velcro strip (not shown) disposed on the bottom surface thereof. The pouch may be removably secured to the encompassing means anywhere along the Velcro strip comprising the attachment means as desired by the subject using the compression device.

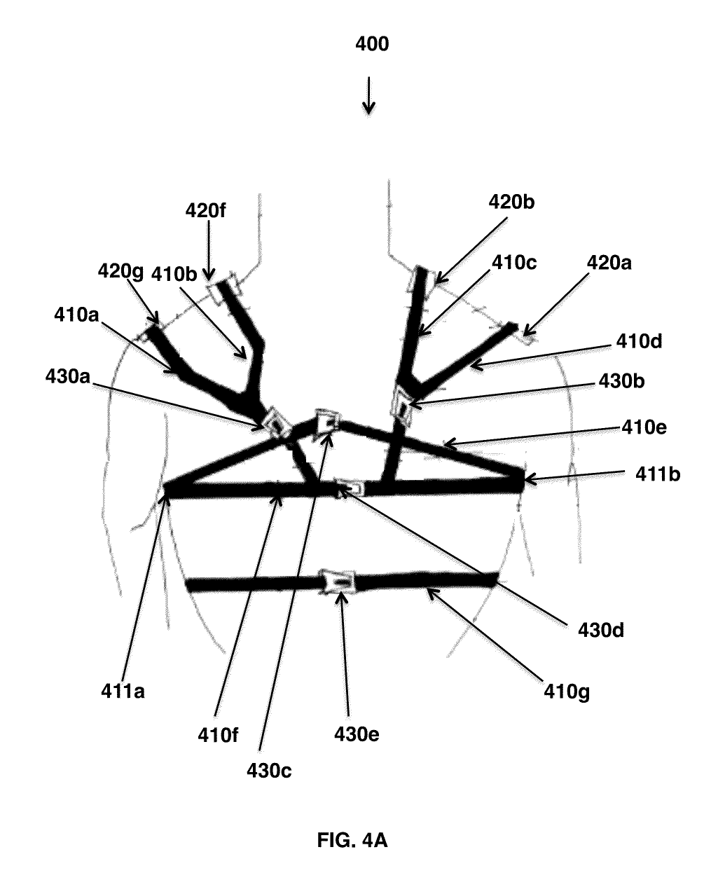

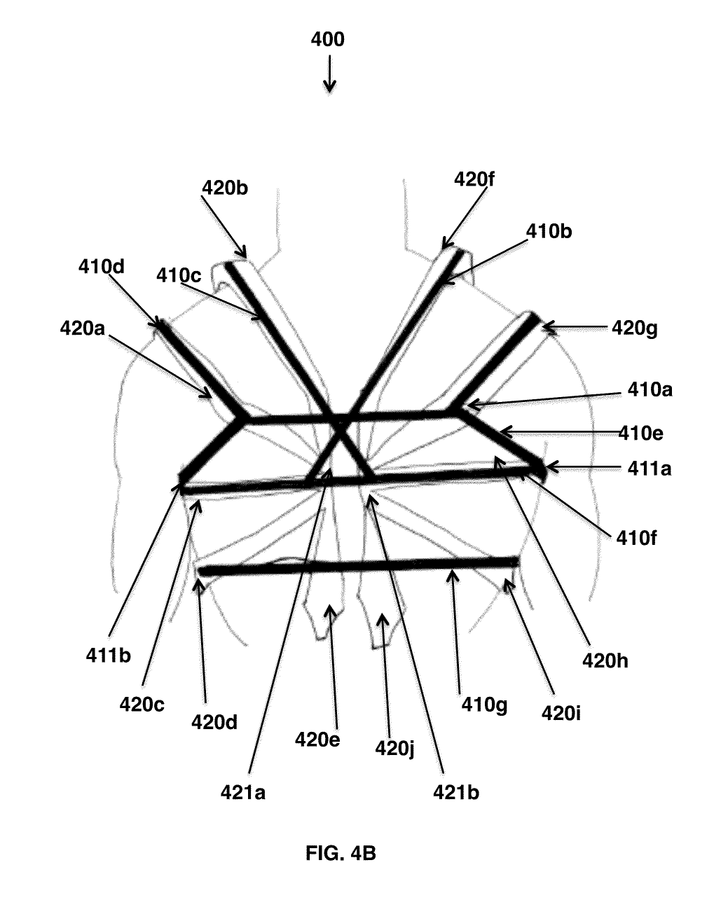

FIGS. 4A and 4B illustrate another embodiment of the self-actuated muscle compression device. The compression device 400 comprises a plurality of encompassing members such as a plurality of straps, for example, but not limited to, neoprene straps, in a vest or a vest-like arrangement that has front portion, as shown in FIG. 4A, covering the chest or upper front torso and a back portion, as shown in FIG. 4B, covering the upper back or upper rear torso of the subject. The device comprises a set of joined encompassing members 410a,b and a set of joined encompassing members 410c,d which are configured to go over the shoulders of a subject and encompassing members 410e,f,g which encircle the upper torso of the subject.

One end of each of encompassing members 410a,d is secured, attached or affixed to the back portion of encompassing member 410f and the other end of each is secured, attached or affixed to front portions of encompassing members 410e,f. Alternatively, encompassing members 410a,d are removably attached, such as with Velcro in a non-limiting example, or reunattached to encompassing member 410e on both the front and back portions. Encompassing member 410e is secured, attached or affixed to encompassing member 410f at 411a,b on the sides of the subject. Thus, the shorter length of the ends of encompassing members 410a,d comprising the back portion of the device and the attachment of the ends comprising the front portion of the device to encompassing member 410e results in a longitudinal separation between encompassing members 410e and 410f on both the upper front and rear torso.

Encompassing members 410b,c depend from encompassing members 410a,d at about a midpoint along the length thereof comprising the front portion of the device and provide additional support and a wider distribution of compression on the shoulders. The end of each of encompassing members 410b,c disposed on the back portion of the device crisscross over the rear upper torso for additional support and are secured, attached or affixed to encompassing member 410f. Encompassing member 410g encircles the torso at a position lower than encompassing member 410f and is separate from and not attached to any of encompassing members 410a-f.

The encompassing members 410a-g may comprise a means for attaching compression members thereto that is disposed on the inner surfaces of the encompassing members. For example, but not limited to such, the attachment means may be Velcro disposed on the inner surface as described for attachment means 330 in FIG. 3. The attachment means need only be disposed on the encompassing members comprising the back portion of the device to substantially cover the same. Alternatively, the attaching means may be disposed on those portions of the encompassing members to which compression members are secured.

The device comprises portioned compression member 420a,b,c,d,e and portioned compression member 420f,g,h,I,j which in combination with the encompassing members form a rigid or semi-rigid web-like structure substantially covering the musculature of the back torso. Portions 420a-e are joined at a common point 421a and extend radially therefrom toward the left shoulder and side of the subject. Mirroring portions 420a-e, portions 420f-j are joined at a common point 421b and extend radially therefrom toward the right shoulder and side of the subject.

The compression member portions may each be completely or partially attached to the inner surfaces of the encompassing members. For example, as described, the outer surfaces of the portions may comprise a male Velcro component to secure to the female Velcro component comprising the attachment means on the encompassing members. It is to be noted that the entire length of each portion of the compression members need not be secured to an encompassing member. The degree of attachment depends on the particular portion to be attached to the encompassing member. For example, as illustrated in FIG. 4B, parts of portion 420a are attached to encompassing members 410b,c,e, parts of portion 420b are attached to encompassing members 410a,c,e, parts of portion 420f are attached to encompassing members 410b,c,e, and parts of portion 420g are attached to encompassing members 410d,e. All of portions 420c,h are attached to encompassing member 410f and parts of portions 420d,e,i,j are individually and separately attached to encompassing member 410g.

A plurality of actuators 430a,b,c,d,e are disposed individually on encompassing members 410a,c,e,f,g on the front portion of the device. The actuators may be any mechanism as described herein. For example, the actuators may be ratchets. Also as described, actuating the actuators tightens the encompassing members around the torso causing the compression members to compress the muscles substantially across the back. All the actuators may be used or specific actuators may be utilized for compression of specific muscles or muscle groups on the back.

The muscle compression device is shown in a closed configuration as worn by the subject. As described in FIG. 1, the tip ends (not shown) of encompassing members 410e,f,g are slidably received through and engagable with the actuators 430c,d,e and are slidably disengable therefrom which can form an opening in the front portion of the device. This enables a subject to put on and remove the device as one would a vest. Alternatively, a subject may disengage all the encompassing members from the actuators to remove the device or may drape disengaged encompassing members 410a-d over the shoulders and bring the disengaged encompassing members 410e-f around the torso such that the back portion of the conjoined encompassing members and compression members substantially covers the upper back torso and re-engage the encompassing members with the actuators. In either instance encompassing member 410f is put on and removed separately from the conjoined encompassing members.

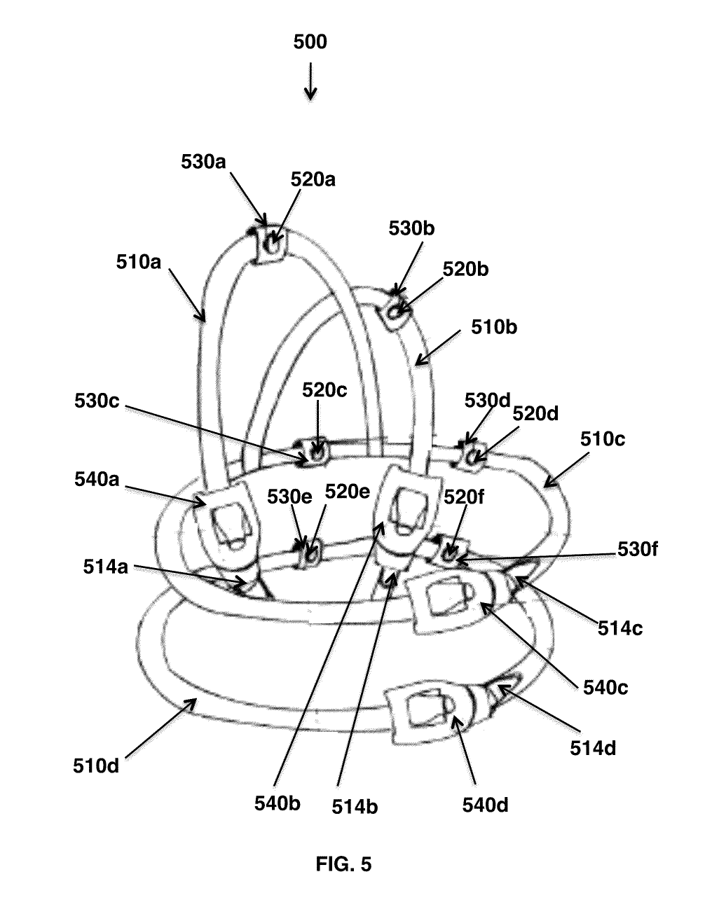

FIG. 5 illustrates another embodiment of the self-actuated muscle compression device. The compression device 500 comprises a plurality of encompassing members such as a plurality of clasping loops, belts or straps as depicted in FIG. 1, in a harness or a harness-like arrangement that has a front portion disposed on the chest or upper front torso and a back portion covering the upper back or upper rear torso of the subject. In this arrangement the device comprises encompassing members 510a,b configured to go over the shoulders of a subject and encompassing members 510c,d which encircle the upper torso of the subject. One end of each of encompassing members 510a,b are secured, attached or affixed to the back portion of encompassing member 510c and the end of each of encompassing members 510a,b are secured, attached or affixed to the front portion of encompassing member 510c such that encompassing members 510a,b rest on the subject's shoulders and encompassing member encircles the subject's torso. Encompassing member 510d encircles the torso at a position lower than encompassing member 510c and is separate from and not attached to any of encompassing members 510a-c.

The device comprises a plurality of movable compression members, as represented by 520a,b,c,d,e,f, disposed on the encompassing members and movably attached thereto via an attachment means 530a,b,c,d,e,f such as described for FIG. 1. Each compression member comprises a node through which a muscle may be compressed upon tightening of the encompassing member comprising the same. The subject may position the compression members at any place along the length of the encompassing member. As such and as described in FIG. 1, the encompassing members each comprise an actuator 540a,b,c,d, for example, but not limited to, a ratchet, through which the tip end 514a,b,c,d of the respective encompassing member is slidably received through and engagable with the actuator and through which they are slidably disengable therefrom. All the actuators may be used or specific actuators may be utilized for compression of specific muscles or muscle groups on the torso.

The muscle compression device 500 is shown in a closed configuration. Similarly to the device 400, when encompassing member 510c is slidably disengaged from actuator 540c, an opening is formed in the front portion of the device and the device may be slipped on over the shoulders and around the torso where encompassing member 510c is re-engaged with the actuator 540c. Alternatively, a subject may disengage all the encompassing members 510a,b,c from their respective actuators to remove the device or may drape disengaged encompassing members 510a,b over the shoulders, bring the disengaged encompassing member 510c around the torso and re-engage the encompassing members 510a,b,c with the actuators 540a,b,c. In either instance encompassing member 510d is put on and removed separately from the conjoined encompassing members. Moreover, the subject may position the compression members as desired on the encompassing members prior to donning the harness and/or may adjust the same prior to actuating the actuators.

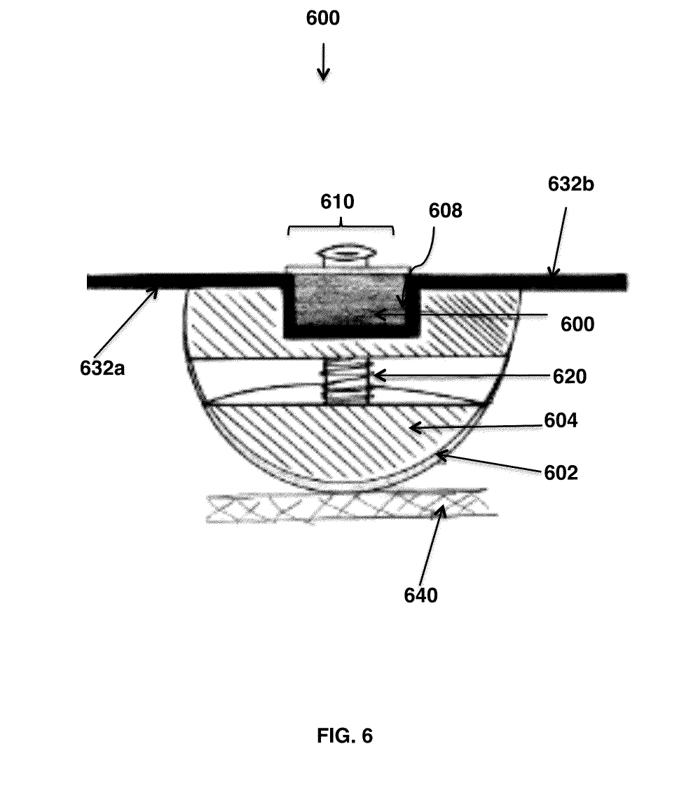

FIG. 6 illustrates in cross-section an embodiment of a compression member. The compression member 600 comprises a means for actuating compression 610 and an actuator 620. The compression member is a pouch 602, for example, a polymer pouch also filled with a polymer 604. The compression member comprises a groove or grooved portion 606 on the back surface thereof and has a width at least equal to that of the flexible encompassing member 630, such as about 1 inch or greater. As described, the back surface of the compression member, including the interior surface 608 of the groove, is secured, affixed or attached to the inner surface 632a of the encompassing member, for example a strap or clasping loop comprising a vest or harness. The actuating means is disposed on the outer surface 632b of the encompassing member in alignment with the groove and in mechanical or electronic communication with the actuator, for example, but not limited to a rod or threaded rod or screw, disposed within the compression member polymer. The actuating means may be, but not limited to, a button, switch, lever or screw head where actuation is accomplished manually or mechanically. Alternatively, the actuating means may comprise an electrical or electronic component or chip and/or may be actuated remotely via a control such as is known in the art. When actuated, the actuator pushes against the polymer causing the compression member to extend or project further than that caused by tightening the encompassing member to which it is attached.

In use, particularly as illustrated in FIG. 6, as the encompassing member is tightened that portion attached within the groove presses downwardly to cause the compressing member to exert a compressive force against the muscle 640. When actuated, the further extension of the compression member by its actuator results in an increase in compression of the muscle without having to further uncomfortably or painfully tighten the encompassing member. For a manual actuating means, actuation generally is performed prior to tightening the encompassing member. With a mechanical, electrical or electronic or remote actuating means, actuation can be performed after the encompassing member has been tightened. Moreover, for example, with a motorized or electronic actuating means, actuation of the compression member can be done remotely and in a sequence of extension and retraction of the actuator on all or selected muscles or muscle groups as desired by the user.

One skilled in the art will appreciate readily that the present invention is well adapted to carry out the objects and obtain the ends and advantages mentioned, as well as those objects, ends and advantages inherent herein. The present devices, methods, procedures, and treatments, described herein are presently representative of preferred embodiments, are exemplary, and are not intended as limitations on the scope of the invention. Changes therein and other uses will occur to those skilled in the art which are encompassed within the spirit of the invention as defined by the scope of the claims.

What is claimed is:

1. A muscle compression device for use by a subject, comprising:
at least one encompassing member having an inner surface and an outer surface, said inner surface substantially contacting a muscle perimeter in at least one location on the subject's skin;
at least one compression member disposed on the inner surface of the encompassing member; and
at least one actuator disposed on the encompassing member in a tightening relationship therewith.

2. The muscle compression device of claim 1, wherein the encompassing member comprises a strap, a semi-rigid or rigid circular clasping loop, a chain, a belt, a rope, or a combination thereof.

3. The muscle compression device of claim 1, wherein the encompassing member and the at least one compressing member are a single member having the compressing members extruded from the inner surface of the encompassing member.

4. The muscle compression device of claim 1, further comprising means for attaching the compression member to the encompassing member.

5. The muscle compression device of claim 4, wherein the attaching means comprises a hook and button closure, glue, velcro, a clip, or a snap or wherein the compressing member is sewn to the encompassing member.

6. The muscle compression device of claim 4, wherein the compression member is removably attached to the encompassing member or is movable along the length of the encompassing member or a combination thereof.

7. The muscle compression device of claim 1, wherein the compression member comprises a polymer, glass, rubber, a dense foam, metal, or wood.

8. The muscle compression device of claim 1, further comprising a compression member actuator and means for actuating the same disposed in the compression member, said actuator extendible within the compression member.

9. The muscle compression device of claim 8, wherein the actuating means comprises manual actuation, electronic actuation or remote actuation and the compression member actuator comprises an extendible rod.

10. The muscle compression device of claim 1, wherein the actuator comprises at least one mechanical element or at least one electrical element or a combination thereof.

11. The muscle compression device of claim 10, wherein the mechanical element is a ratchet, a leveraging tool, a rod, a toothed wheel, an eccentric wheel, or a pulley.

12. The muscle compression device of claim 10, wherein the electrical element comprises a battery operated ratchet or a motorized pulley.

13. The muscle compression device of claim 1, wherein a plurality of the encompassing members are interconnected to form a shoulder portion, a front portion and a back portion encircling the torso, said compression elements attached at a plurality of locations along the encompassing members and said actuators disposed on the encompassing members on the front portion.

14. The muscle compression device of claim 13, wherein the device comprises a vest with a pair of compression elements on the back portion of the device each having a plurality of portions extending laterally therefrom and attached to locations on more than one encompassing member or affixed to one encompassing member.

15. The muscle compression device of claim 13, wherein the device comprises a harness with a plurality of compression elements each being a single compression node movably secured at any positions along the encompassing members.

16. A method for compressing a muscle at a target site on a subject in need thereof comprising the steps of:
positioning the device of claim 1 on the subject;
tightening one or more encompassing members via the actuators comprising the device; and
contacting the muscle target site with one or more of the compression members disposed on the encompassing members with an increasing pressure as the encompassing members tighten, thereby compressing the muscle at the target site in the subject.

17. The method of claim 16, wherein the compression members comprise an actuator and means for actuating the same, the method comprising:
actuating, manually or electronically, the actuator prior to or after the tightening step.

18. The method of claim 16, wherein the subject suffers from muscular pain or from altered reciprocal inhibition of the muscle or has a decreased range of muscular motion.

19. A self-actuating muscle compression device, comprising:
a plurality of interconnected encompassing members forming a shoulder portion, a front portion and a back portion as a single piece;
a pair of compression members disposed on the inner surfaces of the encompassing members on the back portion of the device and each having a plurality of portions extending laterally therefrom, each of said portions attached to more than one of the encompassing members or attached to one encompassing member; and
a plurality of actuators disposed on the encompassing members on the front portion in tightening relationships therewith.

20. The self-actuating muscle compression device of claim 19, further comprising:
a single encompassing member separate from the interconnected encompassing members and having one or more of the portions of the compression members attached thereto; and
an actuator disposed on the encompassing member on the front portion in a tightening relationship therewith.

21. The self-actuating muscle compression device of claim 20, wherein the compression members comprise a plurality of polymer-filled pouches each having an actuator and means for actuating the same.

22. The self-actuating muscle compression device of claim 21, wherein the actuating means comprises manual actuation, electronic actuation or remote actuation.

23. The self-actuating muscle compression device of claim 20, wherein the single piece comprises a vest wearable by a subject.

24. A self-actuating muscle compression device, comprising:
a plurality of interconnected encompassing members forming a shoulder portion, a front portion and a back portion as a single piece;
a plurality of compression members each being a single compression node movably secured at any positions on inner surfaces of the encompassing members; and
a plurality of actuators disposed on the encompassing members on the front portion in tightening relationships therewith.

25. The self-actuating muscle compression device of claim 24, further comprising:
a single encompassing member separate from the interconnected encompassing members;
one or more compression members movably secured at any position on an inner surface of the encompassing member; and
an actuator disposed on the encompassing member in a tightening relationship therewith.

26. The self-actuating muscle compression device of claim 24, wherein the compression members comprise polymer-filled pouches each having an extendible actuator rod disposed therein and means for actuating the same.

27. The self-actuating muscle compression device of claim 26, wherein the actuating means comprises manual actuation, electronic actuation or remote actuation

28. The self-actuating muscle compression device of claim 24, wherein the single piece comprises a harness wearable by a subject.
